(19) United States
(12) Patent Application Publication
(10) Pub. No.: US 2009/0050411 A1
(43) Pub. Date: Feb. 26, 2009

(54) Industrial Robot Lubricated with a polyglycol-Based Lubricant

(76) Inventors: Staffan Ellqvist, Vasteras (SE); Pierre Mikaelsson, Vasteras (SE); Per Lindblom, Vasteras (SE)

Correspondence Address: VENABLE LLP, P.O. BOX 34385, WASHINGTON, DC, 20043-9998, US

(21) Appl. No.: 11/795,879

(22) PCT Filed: Jan. 23, 2006
(86) PCT No.: PCT/EP06/50378

§ 371 Date: Nov. 12, 2008

Related U.S. Application Data
(60) Provisional application No. 60/649,142, filed on Feb. 3, 2005.

(30) Foreign Application Priority Data
Jan. 24, 2005 (SE) 0500182-1

(51) Int. Cl. F16H 57/04; B25J 11/00

(52) U.S. Cl. 184/6.12

(57) ABSTRACT

An industrial robot including a plurality of power transmission units. At least one of the power transmission units is a compact transmission unit including a rotary vector gear reducer arranged to be lubricated with a polyglycol-based lubricant.

### TECHNICAL FIELD OF THE INVENTION

The present invention concerns an industrial robot comprising at least one power transmission unit i.e. an assembly of movable mechanical parts, such as gears and shafts, by which power is transmitted.

### BACKGROUND

Oil is a complex combination of hydrocarbons and additives. The oil itself is made up of long chains of molecules that can be sheared by mechanical motion inside an industrial robot. The oil's ability to withstand loads and to separate moving components without allowing contact is decreased as the molecule chains become shorter. Additives are usually added to oil to increase viscosity, prevent corrosion, suspend particles and prevent foaming for example, however these additives become less effective with time. Furthermore oil in an industrial robot is sometimes exposed to high temperatures, which causes the additives in oils to break down.

The oil in an industrial robot therefore has to be monitored and changed regularly to avoid the wear of bearing components in power transmission units and thus breakdowns and unscheduled stops. How regularly an oil has to be changed depends on amount and type of work that a robot carries out.

The oil inspection and changing process may involve removing the entire robot from its work station. This is the case if the industrial robot is used in a hazardous environment or in hygienic conditions, such as in a workplace involving the processing, manufacturing or packaging of food or medical supplies for example. The robot has to be removed from its work station for maintenance so as not to contaminate the environment with oil and dirt or to subject a technician to hazardous conditions.

The current trend within industrial robots is to increase payload, speed and performance, which results in higher gearbox temperatures. Problems are arising because the generation of heat in the gearboxes is getting too high for conventional lubricants to cool and lubricate the gears. This is especially the case in compact gearboxes that are more difficult to lubricate due to the complex and compact gears, sliding surfaces and fast rotating bearings. Too high temperatures in the robot's gearbox drastically decrease the lifetime of the gears and increase the risk of frequent shut down and expensive repair work.

The mineral and synthetic oils, such as polyalfaolifine-based oils, which are currently used as lubricants in industrial robots must therefore be inspected and changed regularly. Changing a robot's oil takes time and increases manufacturing and labour costs.

### SUMMARY OF THE INVENTION

The object of the present invention is to reduce or eliminate the need to inspect and change the lubricant in an industrial robot and consequently to reduce the downtime of the industrial robot.

This object is fulfilled by using a polyglycol-based (i.e. polyalkylene glycol-based) lubricant in an industrial robot or in at least part of at least one power transmission unit of an industrial robot. The expression “lubricant” is intended to mean a substance, such as grease, oil, paste or spray, which is capable of reducing friction, heat and wear when introduced between solid surfaces.

According to an embodiment of the invention such an industrial robot is used in hygienic, hazardous and/or confined environments.

The present invention also concerns an industrial robot comprising at least one power transmission unit where at least some of the elements of said at least one power transmission unit are lubricated with a ployglycol-based lubricant.

Experiments have shown that using a polyglycol-based lubricant in an industrial robot is capable of lubricating the power transmission units of industrial robots. A polyglycol-based lubricant has very good temperature stability, it does not deteriorate with time, it has a long lifetime and it has a more uniform viscosity over the entire operating temperature range, which results in an increased term of maintenance-free robot use. Furthermore the polyglycol-based lubricant may be applied to the industrial robot for testing the robot prior to delivery to a customer without the manufacturer having to change the oil before delivery. Since the polyglycol-based lubricant does not deteriorate with time, it will last for the entire lifetime of the robot.

Using a polyglycol-based lubricant also reduces or eliminates the need to use additives in the lubricant. This in turn leads to cost savings and makes the lubricant more environmentally friendly and easy to use as compared to conventional mineral and synthetic oils. Experiments have shown that the polyglycol-based lubricant is compatible with conventional seal and gasket materials.

According to an embodiment of the invention said polyglycol-based lubricant is a Tivela® oil, available from Shell. Tivela S oils are high performance, anti-wear, synthetic polyalkylene glycol-based oils with an extremely high viscosity index. They are resistant to the formation of harmful oxidation products, which results in a cleaner oil.

According to another embodiment of the invention said at least one power transmission unit comprises compact components such as a worm gear unit, worm reduction gears, worm transmission, a worm gear mechanism or rotary vector (RV-) gear reducer. An RV gear reducer is a commercially available precision, heavy-duty gear reducer having specially designed built-in output bearings that support large thrust and overhung loads. It offers high ratio gear reduction in a compact design and is therefore ideal for industrial robot applications. Experiments have shown that polyglycol-based lubricants are capable of lubricating the complex and compact gears, sliding surfaces and fast rotating bearings.

According to a further embodiment of the invention the industrial robot comprises least one power transmission unit at least one of its axes. A robot with six axes may for example have a power transmission unit lubricated by a polyglycol-based lubricant at each of its six axes or just at selected axes such as at axis 4, 5 and/or 6, which normally comprise compact power transmission components. The invention is however applicable for use in any industrial robot having any number of axes, such as a robot with four, five or seven axes, and the polyglycol-based lubricant may be used to lubricate any or all of a robot's power transmission units or parts thereof.

According to yet a further embodiment of the invention the industrial robot comprises at least one compartment that comprises at least some of the elements of at least one power transmission unit and said lubricant. According to an embodiment of the invention the industrial robot comprises at least one common compartment that contains a plurality of power transmission units and the polyglycol-based lubricant. According to a further embodiment of the invention the, or each compartment is substantially fluid-tight. According to an embodiment of the invention the industrial robot comprises means to circulate the polyglycol-based lubricant around the, or each compartment, by means of a pump for example. This allows a uniform temperature to be obtained in the whole of the, or each compartment.

The present invention even concerns a method of cooling and lubricating an industrial robot comprising at least one power transmission unit. The method comprises the step of providing the, or each power transmission unit with a polyglycol-based lubricant. According to an embodiment of the invention the method comprises the step of circulating the polyglycol-based lubricant around one or more fluid-tight compartments containing one or more power transmission units.

Experiments have shown that using a polyglycol-based lubricant, such as Tivela oil, in the gearbox of an industrial robot means that the lubricant does not have to be changed at all during the robot's lifetime, which is a huge improvement over today's mineral oil and synthetic oil lubricants which have to be changed after about 12,000 hours service (i.e. approximately every three years during a robot's lifetime).

The industrial robot according to any of the embodiments of the invention is suitable for use particularly but not exclusively in hygienic, hazardous and/or confined environments. More compact power transmission units may be utilised in applications where space is confined since a polyglycol-based lubricant is able to lubricate such smaller power transmission units.

Further advantages as well as advantageous features of the invention appear from the following description and the other dependent claims.

### BRIEF DESCRIPTION OF THE DRAWINGS

FIG. 1 shows a conventional robot with six axes, and

FIG. 2 shows part of a power transmission unit.

It should be noted that the figures are not drawn to scale and that the size of certain features has been exaggerated for the sake of clarity.

The following description and drawing are not intended to limit the present invention to the embodiment disclosed. The embodiment disclosed merely exemplifies the principles of the present invention.

### DETAILED DESCRIPTION OF EMBODIMENTS OF THE INVENTION

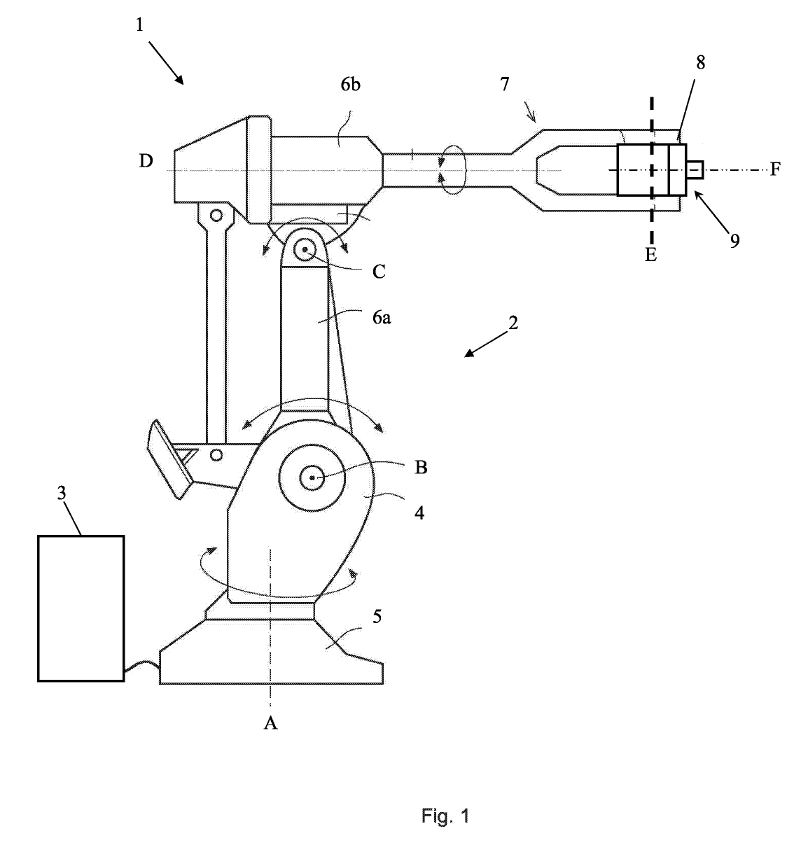

FIG. 1 shows a conventional industrial robot 1 with six axes (A, B, C, D, E, F). The robot 1 comprises a manipulator 2 and a control unit 3. The robot 1 has a stand 4 that is rotatably mounted on a robot foot 5, which enables it to rotate about vertical axis A (commonly referred to as “axis 1”). The robot 1 also comprises a robot arm 6 constituted of a lower arm 6a and an upper arm 6b. The lower robot arm 6a is pivotably mounted about axis B (“axis 2”) and supports the robot's upper arm 6b. The lower and upper arms are pivoted about axis C (“axis 3”). The upper arm 6b comprises a first and a second part. The first part is pivoted about axis C. The second part is rotatably mounted to enable rotation about axis D (“axis 4”) that coincides with the longitudinal axis of the upper arm 6b.

A wrist 7 is mounted on the distal end of the upper arm 6b. The wrist 7 comprises supporting means in the form of a fork-like extension 8. Supporting means hold a rotary robot tool, such as a drill 9, which is pivotably mounted on the wrist 7 so that the tilt can rotate about axis E (“axis 5”). When powered the output shaft of the rotary robot tool 9 rotates about axis F (“axis 6”).

The industrial robot 1 comprises drive means, such as motors, and power transmission units to transmit power from the drive means to move the various movable parts of the robot 1. A polyglycol-based lubricant, such as Shell's Tivela S oil with a viscosity index of 150 for example, is used to lubricate primary and secondary gearboxes located at axes D, E and F to maintain the smooth operation of the robot 1.

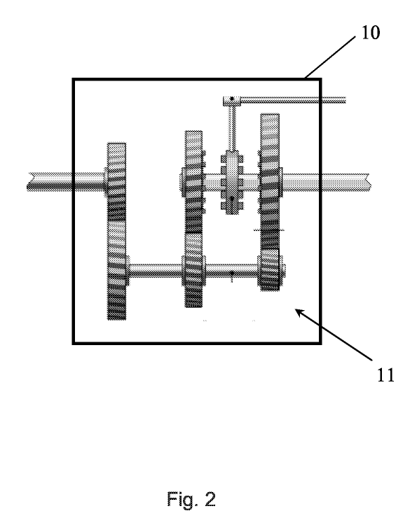

FIG. 2 shows a fluid-tight compartment 10 comprising some of the elements of an industrial robot's power transmission unit 11. Said elements are lubricated with a polyglycol-based lubricant of the desired viscosity.

Since polyglycol-based lubricants are not compatible with conventional mineral oils, these lubricants should not be mixed. In order to prevent unintentional mixing the industrial robot may be provided with labels that disclose the lubricant type that is used at each lubricant-filling-point. If a conventional lubricant is to be replaced by a polyglycol-based lubricant, the conventional lubricant should firstly be flushed with a small quantity of the polyglycol-based lubricant. The industrial robot should then be operated under no load and the used lubricant should then be drained off whilst warm. This procedure may be repeated if necessary until the industrial robot is free of mineral oil and it may then be lubricated with polyglycol-based lubricant and put back to work.

The invention is of course not in any way restricted to the embodiments thereof described above, but many possibilities to modifications thereof would be apparent to a man with ordinary skill in the art without departing from the basic idea of the invention as defined in the appended claims.

1-13. (canceled)

14. An industrial robot, comprising:
a plurality of power transmission units, wherein at least one of the power transmission units is a compact transmission unit comprising a rotary vector gear reducer arranged to be lubricated with a polyglycol-based lubricant.

15. The industrial robot according to claim 14, wherein said polyglycol-based lubricant is a polyalkene glycol-based oil.

16. The industrial robot according claim 14, wherein the at least one rotary vector gear reducer unit is arranged at one axis of the robot.

17. The industrial robot according to claim 14, further comprising:
at least one compartment including at least some of the elements of said at least one rotary vector gear reducer unit and the polyglycol-based lubricant.

18. The industrial robot according to claim 17, further comprising:
at least one common compartment including a plurality of rotary vector gear reducer units and the polyglycol-based lubricant.

19. The industrial robot according to claim 17, wherein said at least one compartment is substantially fluid-tight.

20. The industrial robot according to claim 17, further comprising:
means to circulate the polyglycol-based lubricant around in said at least one compartment.

21. A method of cooling and lubricating an industrial robot comprising at least one rotary vector gear reducer unit, the method comprising:
providing the at least one a rotary vector gear reducer unit with a polyglycol-based lubricant.

22. The method according to claim 21, further comprising:
circulating the polyglycol-based lubricant around at least one compartment that includes the at least one rotary vector gear reducer unit.

23. Use of a polyglycol-based lubricant in at least part of at least one power transmission unit of an industrial robot comprising a rotary vector gear reducer unit.

24. Use of an industrial robot according to claim 1 in hygienic, hazardous and/or confined environments.
